(19) United States
(12) Patent Application Publication
(10) Pub. No.: US 2010/0198686 A1
(43) Pub. Date: Aug. 5, 2010

(54) METHOD AND SYSTEM FOR AGGLOMERATED MOBILE MARKETING

(76) Inventors: Isaac David Guedalia, Bet Shemesh (IL); Mark Jacobstein, San Francisco, CA (US)

Correspondence Address: Intrinsic Law Corp., 235 Bear Hill Road, Suite 301, Waltham, MA, 02451, US

(21) Appl. No.: 12/607,552

(22) Filed: Oct. 28, 2009

Related U.S. Application Data
(60) Provisional application No. 61/108,898, filed on Oct. 28, 2008.

(51) Int. Cl. G06Q 30/00; G06F 15/16

(52) U.S. Cl. 705/14.53; 709/204

(57) ABSTRACT

A method and system for delivery of feeds is provided whereby the feeds are delivered to a mobile subscriber by way of a server associated with the mobile subscriber. The server includes hardware and software to streamline and control the delivery of the feed information to the mobile device of the subscriber as well as the capability to determine with an advertising engine select key word based advertising content to be provided to the subscriber.

### I. RELATED APPLICATIONS

This application claims priority to U.S. Provisional Application No. 61/108,898 tiled Oct. 28, 2008, the entirety of which is incorporated by reference herein.

### II. TECHNICAL FIELD

The present application relates to the delivery of content to mobile computing devices. In particular, the application is directed to the agglomerated delivery of such content in the form of “feeds” from up to several sources of content to a mobile device by way of a server, and further to determine an effective set of information, including advertising content, that would be suitable for delivery to a subscriber.

### III. BACKGROUND

A common way to distribute information of interest to users of the Internet is by way of channels or “feeds” or syndicated broadcasts of frequently-updated information to select users. The users generally subscribe to the selected feeds. The feeds can include blog entries, news bulletins, sports updates, or any form of updatable distribution of content. The Really Simple Syndication (“RSS”) feed model is one common way to distribute such information to subscribers. A standardized extended markup language (“XML”) format can be used to publish updates to the feeds and have the updates propagate to all syndicated outlets and subscribers thereof.

There is typically no co-ordination between sources of feeds, and so there is little control over how many feed channels a user subscribes to. In addition, there is generally no control by a subscriber over how much information will be send through the feed channels to the subscriber with each given feed update, or the frequency of such updates. Therefore, the total amount of data sent to a user subscribing to several (or many) feeds is variable and is unknown in advance and is not generally under the control of the subscriber.

In general, a subscriber provides a source of content with information about the subscriber (such as an address) so that the source of the feed can directly send the updates or feeds to the subscriber as they become available. If a subscriber subscribes to many such channels or feeds from a mobile device such as a cellular phone the incoming feed information can overwhelm or excessively tax the resources of the mobile device. In some instances, if too many mobile resources are required to service the feeds, the mobile device can experience problems and even crash or become corrupted or inoperable. This can occur in some cases because there is no mechanism for streamlining the flow of information to the mobile device or coordinating the use of the resources of the mobile device for such purposes.

The present disclosure presents several embodiments of methods and systems for deliver and reception of information, especially as relates to subscribers receiving updates and feeds from multiple channels to a mobile device.

### IV. SUMMARY

It can be seen from the above discussion of the limitations of present feed subscription systems and models for distribution of feed data that improvements can be useful in this field. The present disclosure provides methods and systems directed to ways to improving the present state of this art and to solving some or all of the above problems.

In some embodiments, a method and system for delivery of feeds is provided whereby the feeds are delivered to a mobile subscriber by way of a server associated with the mobile subscriber. The server includes hardware and software to streamline and control the delivery of the feed information to the mobile device of the subscriber.

In certain embodiments, there is a Prioritizer or hardware and/or software for prioritizing the various feeds in a multi-feed or multi-channel environment so that the higher priority feeds are delivered preferentially to the subscriber. Also, filtering, editing, modifying, and otherwise controlling the feed information can be implemented in the server to avoid overloading the resources of the subscriber's mobile device or the bandwidth available to the subscriber. The server, and in certain contexts, the server in co-operation with the mobile device, can control the delivery of the syndicated feed data to the mobile device in a regulated fashion that optimizes the use of the available resources of the mobile device and the bandwidth available to it.

Yet other embodiments include a mechanism for determining an effective set of information, e.g., advertising information to deliver to a mobile subscriber as a result of the determinations made by the prioritizing server and/or the preferences, profile, or usage history of the subscriber.

### V. BRIEF DESCRIPTION OF THE DRAWINGS

For a fuller understanding of the nature and advantages of the present inventions, reference is be made to the following detailed description of preferred embodiments and in connection with the accompanying drawings, in which:

FIG. 1 illustrates an exemplary architecture for an agglomerating and prioritizing, server having multiple feed inputs and a resulting output to a subscriber;

FIG. 2 illustrates an exemplary table describing a plurality of available feeds;

FIG. 3 illustrates an exemplary priority list of RSS feeds from FIG. 2 that may be selected according to an embodiment;

FIG. 6 illustrates steps of an exemplary method for providing the targeted agglomerated advertising to a mobile subscriber;

FIG. 7 illustrates another exemplary method for providing targeted agglomerated advertising to a mobile subscriber;

FIG. 8 illustrates another exemplary system for providing agglomerated content to a target mobile subscriber; and

FIG. 9 illustrates an exemplary method for providing agglomerated content to a target mobile subscriber using the system of FIG. 8.

### VI. DETAILED DESCRIPTION

As mentioned above, the present disclosure is directed to various ways to improve the model of feed provisioning, especially to mobile devices. In particular, embodiments hereof are directed to providing effective and safe methods and systems for delivery of subscriber data by way of syndicated feed channels through a server which controls and optimizes the delivery of the feeds from multiple providers to a mobile subscriber.

Prioritizing the feeds from multiple sources is one way of controlling the flow of information to the mobile subscriber. The prioritizing can be accomplished by using a server to agglomerate or aggregate the feed data and prepare it for delivery to the subscriber's mobile device. Hardware and/or software, which can include standard computer hardware running software referred to as a “prioritizer” in some embodiments is one way to accomplish the objective of prioritizing feeds. The prioritizer can sort the data across the feeds so as to prioritize the feeds by certain criteria. These criteria can, for example, include the source of the feed, the popularity of the feed, the date of the feed, the time of publication, the feed's bandwidth requirement, or other context-dependent criteria.

Once prioritized, the prioritizer, in conjunction with the server containing the prioritizer, or in conjunction with another server controlling delivery of the feeds to the subscriber, will control the delivery of select feeds or feed data to the mobile device. The select feeds can, for example, be a select number of highest priority feeds (e.g., top ten feeds). In some embodiments, the prioritizer may selectively merge certain feeds and include them in a Priority List of favorite or top priority feeds.

Formatting of the information sent to the mobile device may be done in a conventional sense so that the selected prioritized feeds are presented on the mobile device in a conventional manner (e.g., using XML), or they may be provided to the mobile device in a special or proprietary format if the mobile device is equipped with special software to accommodate the special format. The mobile device may then display the Priority List to the subscriber or user of the device. The display may include a heading or a short description or a link that can be selected by the subscriber to obtain more information about the feed. The mobile device may receive and/or display an abbreviated or truncated set of information for each of the non-prioritized feeds (for example, just the title), or may in some embodiments not be provided with any information relating to non-prioritized feeds. In some embodiments, the subscriber may edit or have an input to the selection of the top priority feeds in the Priority List, or the selection can he accomplished automatically using a program running along with the prioritizer software.

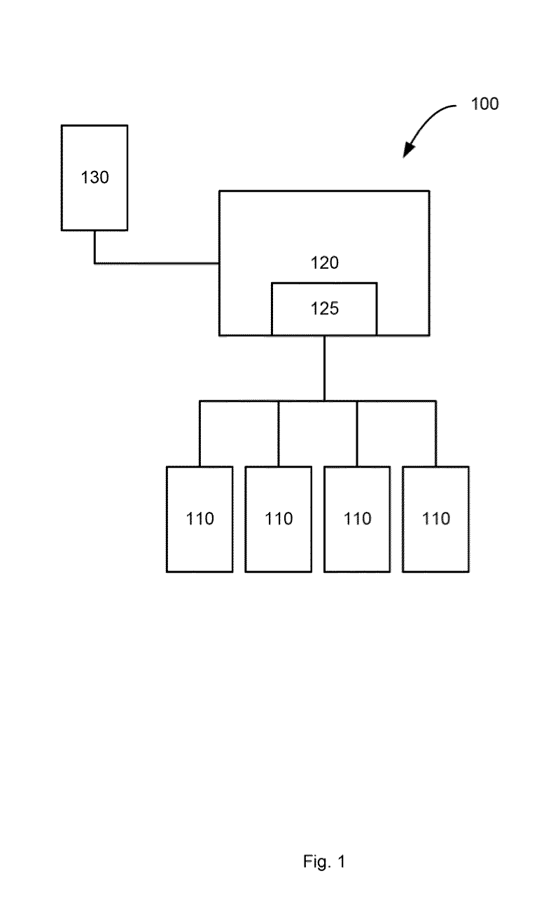

FIG. 1 illustrates an exemplary embodiment of an architecture for a system 100 that includes an agglomerator server 120 having a prioritizer portion 125 therein. The agglomerator server 120 is coupled to one or more sources of feed data, or feed servers, 110, which provide respective feed content or channels. The server 120 is also coupled to a mobile subscriber device 130. In certain embodiments, agglomerator server 120 may service more than one subscriber (not shown) in a similar way, having information corresponding to the several subscribers kept accessible or stored in said server. Agglomerator server 120 may include at least one microprocessor for processing machine-readable instructions or code. The microprocessor may be the same or similar to those used in traditional computer systems and server machines, and may be connected by buswork and interfaces to at least one data storage apparatus or database for storing digital data.

Agglomerator server 120 may include an input device or several input devices and may include one or more output devices such as a computer display output device. In an embodiment, the server 120 may receive one or more RSS feeds from one or more feed servers 110 associated with one or more RSS service providers that are destined for a mobile device 130. In an embodiment, an RSS feed may be associated with one or more data elements. A data element may describe an RSS feed. For example, a data element may be an identification value, a date the feed is published, an RSS service provider associated with the feed, a popularity value associated with an RSS feed, a title associated with the feed and/or the like. It is understood that additional and/or alternate criteria may be used to sort received RSS feeds within the scope of this disclosure.

In some embodiments, a plurality of feed servers 110 of feed content or channels are individually coupled to the agglomerator server 120. The agglomerator server 120 may act as a proxy for the subscriber 130, and may use subscriber information (e.g., ID, address, account data) to register itself with each feed. The feed servers 110 may be unaware that a agglomerator server 120 is in fact receiving the feed data as opposed to the subscriber device 130.

The prioritizing portion of the server (prioritizer 125) receives the feed data from the feed servers 110. The prioritizer 125 then performs prioritization processing on the feeds received as described above, in order to determine a select or best set of feed information to deliver to subscriber 130. Appropriate input and output interfaces, application programming interfaces (APIs) or other connections between agglomerator server 120 and the feed servers 110 are included in some embodiments, and the coupling between the feed servers 110 and the agglomerator server 120 may include one or more network connections such as those used for exchanging XML feed data or TCP/IP protocol data.

Agglomerator server 120 or a component or other server coupled thereto may include, in some embodiments, an agglomerator or load balancer for properly receiving and processing information from multiple sources. Also, agglomerator server 120 may include or be coupled to another server that provides selected advertising for subscriber 130 using an advertisement engine. Advertising engines can comprise similar elements to those used in present client-server systems for preparing and delivering targeted advertising to customers. It will not be explained in detail here, but the advertising engine may comprise hardware and/or software for determining a likelihood of an advertisement to be effective with a particular target audience or subscriber 130. Subscriber history, usage, profile and demographic information, as well as segmentation techniques relating to the customer segment of the customer and product sets which apply may be used to determine the appropriate advertising information to be made available, to a given subscriber.

In some embodiments, agglomerator server 120 may identify the actions of a particular mobile device user (subscriber) by using a unique identifier associated with the user, the session and/or the like. For example, the agglomerator computing device may associate a user's actions with the user's mobile subscriber ISDN (“MSIDN”). In an embodiment, the time of each action may also be logged.

In other embodiments, agglomerator server 120 may compile a list of keywords from one or more logged actions. Exemplary actions may include utilizing mobile device services such as placing telephone calls, composing and/or receiving emails, using the Internet, subscribing to and/or receiving RSS feeds, setting user preferences and/or the like. For example, if a mobile device user performs an Internet search for the word “New York,” then the agglomerator computing device may add “New York” to its list of keywords. Similarly, if a user subscribes to an RSS feed from a particular website, the website name, the RSS feed topic and/or other information corresponding to the RSS feed may be added to the keyword list.

In yet other embodiments, a mobile subscriber device 130 may utilize several (e.g., four) browser; windows on his or her mobile device to receive the feed information and interact with the system 100. In one window, the user may be using a search engine to search for the word “shoes.” In the second window, the user may be browsing a sports website. In the third window, the user may be reading a news website. In the fourth window, the user may be using a search engine to search for the query “weather in San Francisco.” In an exemplary embodiment, the keyword list associated with the user may include the words “shoes,” “sports,” “basketball,” “news,” “weather,” “San Francisco” and/or the like. All of these, and optionally in combination with historical data, information from analogous transactions, and data mining results, can be used to optimize the results delivered to the mobile subscriber 130.

As mentioned above, the system 100, and in particular, the agglomerator server 120 may send a keyword list to the advertisement engine. The advertisement engine may use one or more words on the keyword list to generate one or more targeted materials for the mobile device user. Targeted materials may include advertisements, promotional materials and/or the like. In an embodiment, the advertisement engine may transmit the targeted materials to the agglomerator computing device. The agglomerator server 120 may transmit the targeted materials to the subscriber's mobile device 130. One or more of the targeted materials may be displayed on the mobile device as an advertisement.

In an embodiment, the targeted materials may include recommendations as to what products, services and/or the like the mobile device user may enjoy based on his keyword list. These recommendations may be displayed on a portion of the mobile device screen, such as on a browser tab. In a specific exemplary embodiment, the targeted materials may include an offer for the mobile device user to sign-up for RSS feeds, software widgets or other services based on the keyword list. This offer may be presented to the mobile device user by his mobile device.

For example, referring to the example above, the user associated with the keyword list including the terms “shoes,” “sports,” “basketball,” “news,” “weather,” “San Francisco” may see a tab displayed on her mobile device entitled “What's New!” which may feature an RSS sports feed, a weather-monitoring software widget, an advertisement from a San Francisco restaurant, an advertisement for a shoe store in San Francisco and/or the like. In an embodiment, the user may see advertisements relating to one or more of her keywords on the webpage she is browsing.

In operation, the agglomerator server 120 may he associated with a service provider. In an embodiment, a service provider may be an organization, entity and/or the like that provides one or more communication services. Exemplary service providers may include wireless service providers, voice-over Internet protocol providers (“VoIP”), mobile solution providers, mobile-to-personal computer (“PC”) communication providers and/or the like. In an embodiment, a service provider may have a corresponding wireless network. A wireless network may enable communication between a plurality of mobile devices, computing devices and/or the like. Examples of wireless networks may include computer networks, the Internet, a telephone network and/or other similar telecommunication networks.

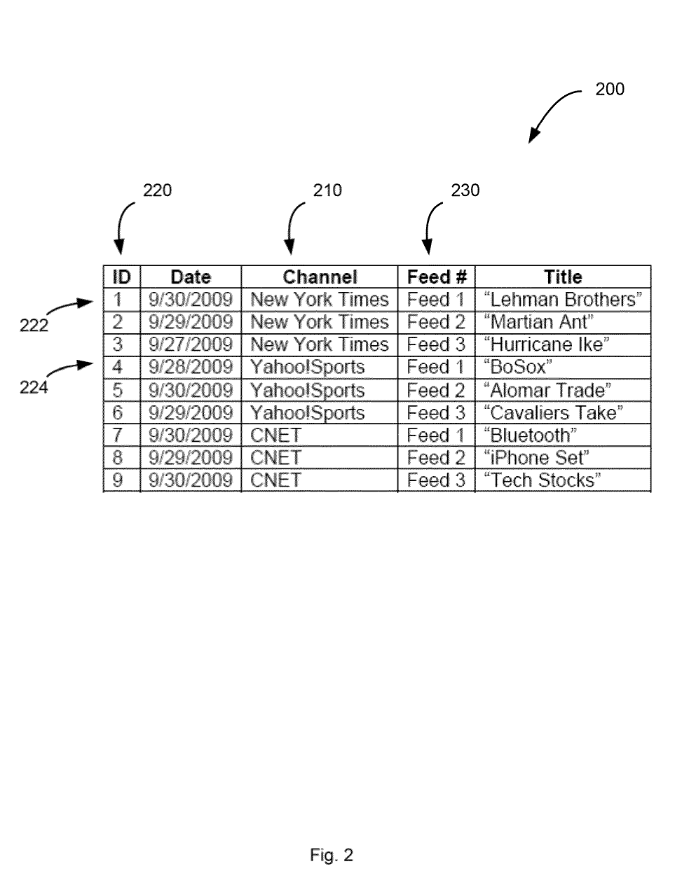

FIG. 2 illustrates an exemplary sorted list 20( )of RSS feeds according to an embodiment. The list 200 may be embodied in a computer-readable medium such as in a data storage system, which may comprise a magnetic or optical storage device or an equivalent thereto. The data in list. 200 may be organized in a number of ways, but can be organized into data structures, arrays, tables, look-up tables, or other structures. As illustrated by FIG. 2, this list 200 is sorted by RSS feed service provider under the column (210) identified as “Channel,” identification numbers (220), and feed numbers (230). In an embodiment, an identification number may be a unique value associated with an RSS feed. In an embodiment, a feed number may identify an RSS feed from other feeds associated with a same service provider. For example, referring to FIG. 2, Feed 1 (222) is identified as “feed 1” within the New York Times set of feeds, while Feed 4 (224) is identified as “feed 1” within the Yahoo!Sports feeds. In addition, a Date (240) and a Title (250) entry may be used to further identify and distinguish the various available feeds.

In an exemplary embodiment, agglomerator server 120 may select one or more RSS feeds from the received feeds based on one or more criteria. For example, a central computing device may select received RSS feeds having a certain date, such as a current date. As another example, a central computing device may select received RSS feeds from a certain service provider, for example, CNN. In an embodiment, a mobile device user may define the criteria used to select one or more RSS feeds. For example, a user may specify that RSS feeds having a current date are to be selected.

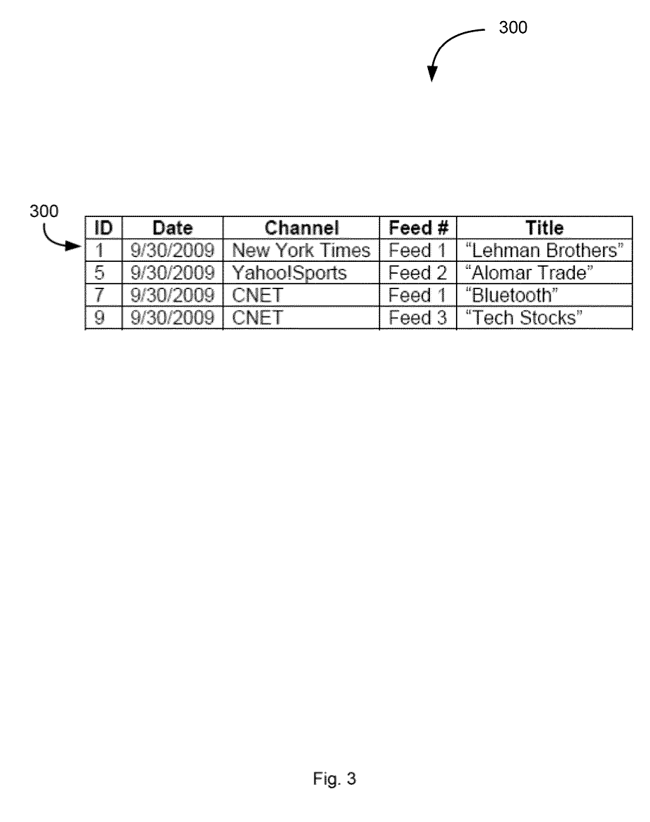

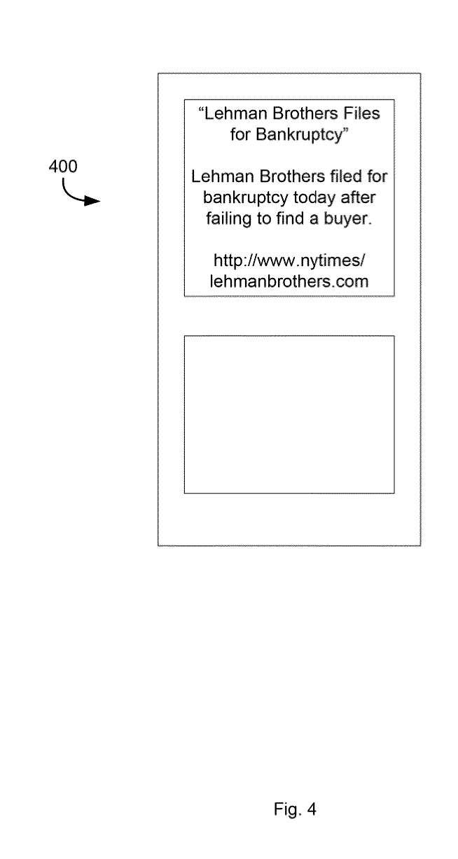

The prioritizer 125 may create a priority list of the selected RSS feeds. The priority list may include one or more of the data elements associated with one or more of the selected feeds. For example, if the selection criteria include RSS feeds having a date of Sep. 30, 2009, FIG. 3 illustrates an exemplary priority list of RSS feeds 300 from FIG. 2 that may be selected according to an embodiment. A condensed description of one or more of the RSS feeds that is not included on the priority list may be displayed on a mobile device. For example, only a headline may be displayed for the RSS feeds not included on the priority list.

FIG. 4 illustrates an exemplary subscriber mobile device display screen 400 showing exemplary information that may be displayed for Feed 1, which is included on the priority list depicted by FIG. 3.

FIG. 5 illustrates an exemplary arrangement of elements within a system 500 that generates, processes, and distributes feed channel information to a mobile subscriber device, and further provides targeted advertising content to said subscriber. One or more sources of feed channel information, e.g., several feed servers 510 provide sources of feed data. The system 500 allows agglomerative mobile marketing according to the discussion given above.

A mobile subscriber 510 expresses an interest and communicates activity through connection with a proxy server 520, which may include an agglomeration server or proxy server 520 as discussed above, in addition to a keyword aggregator 525, or a prioritizer, or an advertising engine, and other components that are directly or indirectly associated with server 520. The server 520 and keyword agglomerator 525 generate a list of key words of interest to subscriber 510. The list of key words is delivered to a search engine 530 or service, e.g., Google advertising engine (by Google, Inc.) or similar engine or service. The key words can be generated from a direct request from the user or from the user's history or profile, or from other preferences, settings, and characteristics associated with the user or subscriber.

In some embodiments, the key words are generated and stored in a spatially or temporally continuous manner, or in a batch format deriving from a serial or sequential pattern of behavior. The time at which the requests or behavior took place may be included in a time stamp or other meta data. The user may be searching for various key words as discussed earlier, optionally each in a separate browser window or user interface module 540. The various key words may be generated, aggregated, and collapsed into a single compact set of key words in some embodiments. A user or subscriber ID may be used by the server 520 to identify the subscriber, e.g., using a MSISDN or other unique session identifier as well.

Target advertising information is then generated and provided from the advertising engine 530 by way of viewable content in windows or other user interface modules 540 that are made available for inspection by the subscriber 510. It should be understood that the present discussion does not only apply to advertising information in the conventional sense, but can also include any type of information or data that is of use in a specific context for sending to a subscriber. In some embodiments, the user interface modules include Web browser or similar windows that display the targeted advertising content from the advertising engine 530. The subscriber 510 may respond to offers presented to the subscriber and made available through the advertising information.

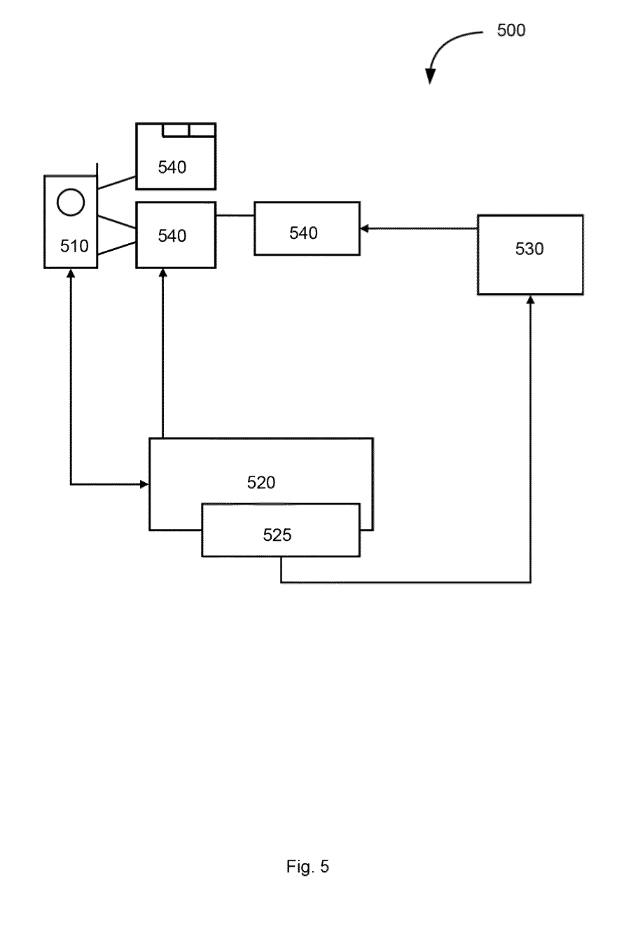

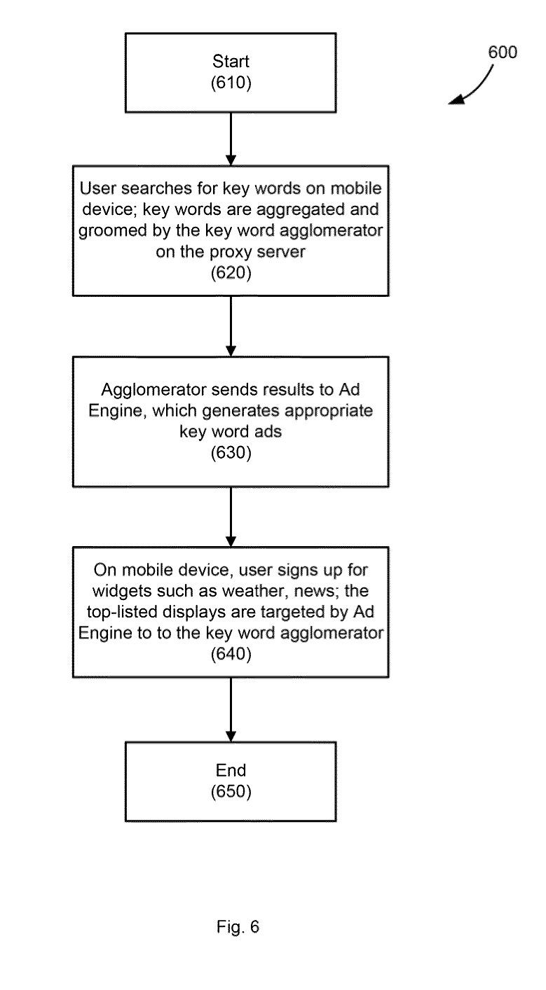

FIG. 6 illustrates steps of an exemplary method for providing the targeted agglomerated advertising to a mobile subscriber. The method begins at Start step 610. The method allows the user to search for key words on his or her mobile device and aggregates, agglomerates, or grooms said key words in a key word agglomerator on the proxy server or agglomerator server at step 620. Next, at step 630, he agglomerator server sends the results of the agglomeration or grooming to an advertising engine, e.g., a Google advertising engine from Google, Inc., which generates appropriate targeted key word based advertising content. Then, at step 640 on the mobile device, the subscriber user can sign up for or choose and send a choice signaling information for widgets such as weather or news or sports, etc. The top-listed displays are those targeted by the advertising engine as a result of the key word agglomeration. The exemplary method ends at End step 650

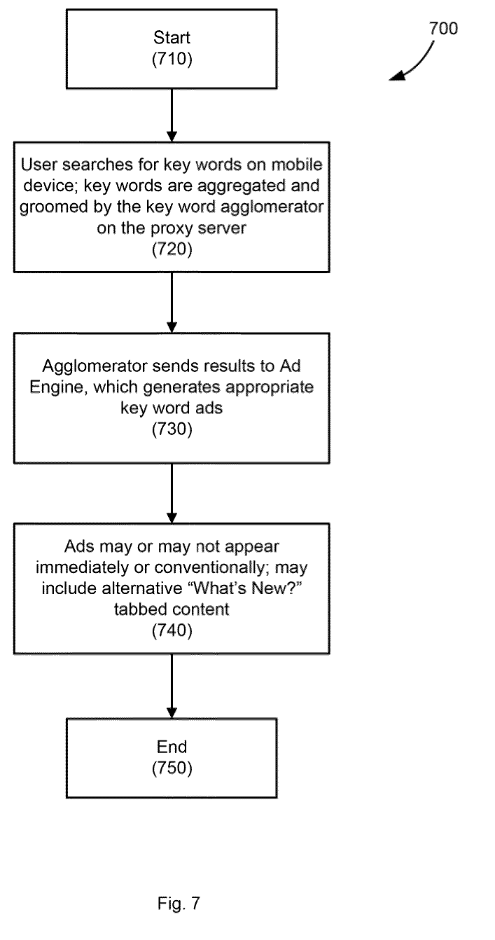

FIG. 7 illustrates another exemplary method for providing targeted agglomerated advertising to a mobile subscriber. Once the exemplary method begins at Start step 710, the user or subscriber searches for key words on his or her mobile device at step 720. The key words are aggregated, agglomerated or groomed by a key word agglomerator as discussed previously for example on a proxy server. At step 730 the agglomerator and/or prioritizer sends results of the agglomeration to an advertising engine for generation of appropriate key word based ads. At step 740, the advertising may or may not appear immediately or conventionally at the subscriber's mobile device. The advertising may take the form of a “What's New?” prompt or other similar prompt to generate curiosity and further interactivity from the subscriber. This may be useful for skeptical subscribers or those who do not respond effectively to traditional push-advertising content. The exemplary methods ends with End step 750.

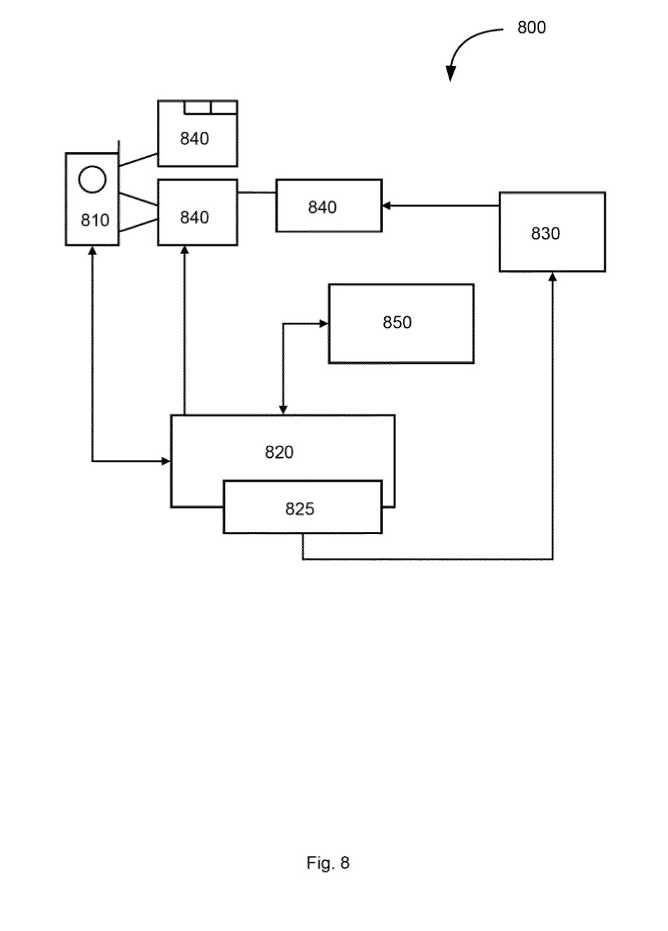

FIG. 8 illustrates another exemplary system for providing agglomerated content to 2 target mobile subscriber. The system 800 includes a mobile subscriber device 810 coupled to a proxy server 820 including or coupled to a key word agglomerator 825 as before. The system couples the proxy server or key word agglomerator 825 to an advertising engine 830 for delivery of groomed key words thereto. The advertising engine 830 provides corresponding output information to various subscriber interaction or user interface modules 840, such as browser windows. In addition, the proxy server 820 is coupled to a location server 850 such as a server operated by a wireless provider and which can generate subscriber identification and location information for use by the proxy server 820.

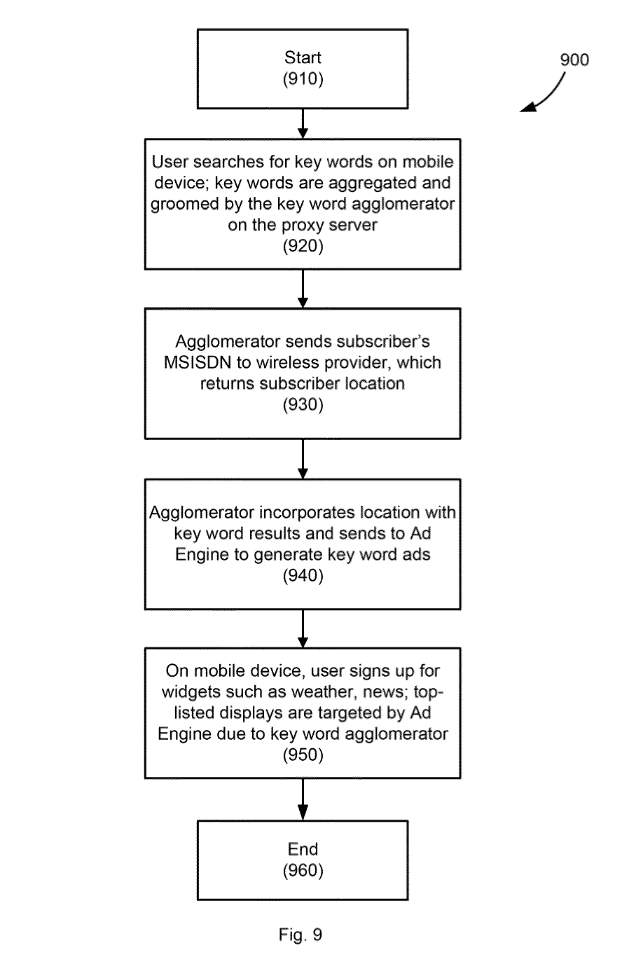

FIG. 9 illustrates an exemplary method for providing agglomerated content to a target mobile subscriber using the system of FIG. 8. The method begins at Start step 910. At step 920, a subscriber user searches for key words on his or her mobile device. The key words are agglomerated, aggregated, or groomed by a key word agglomorater in a proxy server as discussed above. The agglomerator server or proxy server, at step 930, sends subscriber identification and other subscriber information to the location server which in turn returns location information on the subscriber to the proxy server. At step 940, the proxy server agglomerator incorporates and uses said location information or other subscriber information with key words that are groomed and sent to an advertising engine. The advertising engine provides targeted advertising content as discussed before that is delivered to the subscriber and viewed and chosen for further activity by the subscriber at step 950. The exemplary method terminates at End step 960.

The present invention should not be considered limited to the particular embodiments described above, but rather should be understood to cover all aspects of the present inventions as would be understood by those skilled in the art upon consideration of the present disclosure and drawings. Various modifications, equivalent processes, as well as numerous structures to which the present invention may be applicable, will be apparent to those skilled in the art to which the present invention is directed upon review of the present disclosure, and are intended to be comprehended by the scope of the present disclosure.

What is claimed is:

1. A system for agglomerating data for a mobile subscriber, comprising:
a first interface for receiving feed data from a plurality of feed sources;
a processor for processing the feed data from the plurality of feed sources, including circuitry for executing instructions to generate one or more outputs indicative of a selected subset of information from said feed data;
a second interface for delivering said selected subset of information to a mobile subscriber.

2. The system of claim 1, said circuitry comprising computer processing circuitry adapted for running computer software to generate said outputs.

3. The system of claim 1, said first interface comprising an interface for communication with said feed sources over a TCP/IP network.

4. The system of claim 1, said feed data comprising RSS feed data.

5. The system of claim 1, further comprising an advertising engine coupled to said processor for determining advertising content to be delivered to said mobile subscriber.

6. The system of claim 1, further comprising a third interface for coupling said processor to a mobile locator service engine and adapted for communicating subscriber-specific information thereby.

7. A method for delivering targeted information to a mobile subscriber, comprising:
storing subscriber identification information corresponding to the mobile subscriber in a data storage apparatus;
receiving subscriber input from the mobile subscriber, including input from a feed selected by said subscriber;
agglomerating said subscriber input and said subscriber identification information in a server which is remote from said mobile subscriber;
determining one or more key words in said server and delivering said key words to an advertising engine; and
delivering advertising results to said mobile subscriber based on said key words.

8. The method of claim 7, further comprising sorting a plurality of available feeds to obtain a prioritized list of feeds.

9. The method of claim 8, further comprising presenting said prioritized list of feeds to said mobile subscriber.

10. The method of claim 9, further comprising receiving a selection from said mobile subscriber indicative of a service or product. chosen by said mobile subscriber.

11. The method of claim 7, further comprising processing said key words to obtain a compact list of select key words for presentation to said advertising engine.
